(19) United States
(12) Patent Application Publication
(10) Pub. No.: US 2025/0259059 A1
(43) Pub. Date: Aug. 14, 2025

(54) SYSTEM, METHOD, AND APPARATUS FOR IMPROVING PERFORMANCE FOR LANGUAGE MODEL

(71) Applicant: LG MANAGEMENT DEVELOPMENT INSTITUTE CO., LTD., Seoul (KR)

(72) Inventors: Changho Lee, Seoul (KR); Janghoon Han, Seoul (KR); Joongbo Shin, Seoul (KR); Nakyeong Yang, Seoul (KR)

(21) Appl. No.: 18/971,122

(22) Filed: Dec. 6, 2024

(30) Foreign Application Priority Data
Feb. 14, 2024 (KR) 10-2024-0021048
Mar. 26, 2024 (KR) 10-2024-0041212

(51) Int. Cl. G06N 3/082

(52) U.S. Cl. CPC G06N 3/082

(57) ABSTRACT

A method for improving a performance for an instruction-following language model including the steps of determining a degree of bias of neurons with respect to an instruction label, selecting one or more biased neuron based on the degree of bias, and removing an influence of the biased neuron.

### CROSS REFERENCE TO RELATED APPLICATIONS

This application claims priority from and the benefit of Korean Patent Application No. 10-2024-0021048 filed on Feb. 14, 2024, and Korean Patent Application No. 10-2024-0041212 filed on Mar. 26, 2024, each of which is incorporated herein by reference for all purposes as if fully set forth herein.

### BACKGROUND

### Field

Embodiments of the invention relate generally to a system, method, and apparatus for improving the performance of a language model, and more specifically, to a system, method, and apparatus for improving the performance of an instruction-following language model by removing biased neurons with respect to instructions.

### Discussion of the Background

Instruction-following language models are language models designed to understand and act on instructions given in natural language. The instruction-following language models are being used in various fields, such as robot control, virtual assistants, and autonomous vehicles. Bias is a statistical tendency to overestimate or underestimate specific parameters in these artificial intelligence models, and the presence of such bias in language models significantly reduces the performance of the language model. Accordingly, research has been conducted to remove such bias by introducing a separate learning module that removes biased data, or by introducing a preprocessing step that detects bias in training data and identifies and removes specific tokens or vocabulary, or to remove label bias, model bias, etc. However, research targeting bias that arises from instructions is lacking, highlighting a need for methods to remove instruction bias.

The above information disclosed in this Background section is only for understanding of the background of the inventive concepts, and, therefore, it may contain information that does not constitute prior art.

### SUMMARY

Embodiments of the invention provide a system, method, and apparatus capable of improving the performance of a language model by identifying biased neurons with respect to instructions.

Additional features of the inventive concepts will be set forth in the description which follows, and in part will be apparent from the description, or may be learned by practice of the inventive concepts.

Embodiments of the invention also provide a system, method, and apparatus for improving the performance for an instruction-following language model by identifying biased neurons.

A method for improving the performance for an instruction-following language model performed by at least one processor according to an embodiment includes the steps of: determining the degree of bias of neurons with respect to an instruction label; selecting one or more biased neuron based on the degree of bias; and removing the influence of the biased neuron.

The method may further include quantifying the bias properties of each neuron, including the steps of: calculating an attribution score for biased outputs for each neuron; and calculating an attribution score for golden outputs for each neuron, in which determining the degree of bias of neurons for the instruction label may include: determining the degree of bias for each neuron, based on the value obtained by subtracting the attribution score for the golden outputs from the attribution score for the biased outputs.

Determining the degree of bias may include: determining a token aggregation score based on the attribution scores calculated for all tokens; determining an instance aggregation score based on the token aggregation score; determining an instruction aggregation score based on the instance aggregation score; and determining the degree of bias corresponding to the instruction aggregation score for each neuron.

Selecting one or more biased neuron may include selecting biased neurons in descending order of degrees of bias, amounting to 0.1% or less of the total number of neurons.

Removing the influence of the biased neuron may include using a pruning method to remove the influence of the selected biased neuron.

The pruning method may include setting a weight factor for the selected biased neurons as 0.

The number of biased neurons selected may be determined based on a performance after comparing performances of less than 0.1% of the total number of neurons.

A system for improving the performance of an instruction-following language model according to another embodiment includes: a memory for storing one or more instructions; and at least one processor that executes the one or more instructions stored in the memory, in which the at least one processor, by executing the one or more instructions, determines the degree of bias of neurons for an instruction label, selects one or more biased neuron based on the degree of bias, and removes the influence of the biased neuron.

The at least one processor, by executing the one or more instructions, may calculate an attribution score for biased outputs for each neuron, calculate an attribution score for golden outputs for each neuron, by quantifying the bias properties of each neuron, and determine the degree of bias for each neuron based on the value obtained by subtracting the attribution score for the golden outputs from the attribution score for the biased outputs.

The at least one processor, by executing the one or more instructions, may determine a token aggregation score based on the attribution scores calculated for all tokens, determine an instance aggregation score based on the token aggregation score, determine an instruction aggregation score based on the instance aggregation score, and determine the degree of bias corresponding to the instruction aggregation score for each neuron.

The at least one processor, by executing the one or more instructions, may select one or more biased neuron may include selecting biased neurons in descending order of degrees of bias, amounting to 0.1% or less of the total number of neurons.

The at least one processor, by executing the one or more instructions, may remove the influence of the selected biased neurons using a pruning method.

One or more non-transitory computer-readable storage medium encoded with instruction that, when executed by one or more computers, cause the one or more computers to perform operations, the operations including; an operation of determining the degree of bias of neurons with respect to an instruction label; an operation of selecting one or more biased neuron based on the degree of bias; and an operation of removing the influence of the biased neuron.

The operations may further include: an operation of quantifying the bias properties of each neuron, in which the operation of quantifying the bias properties of each neuron may include: an operation of calculating an attribution score for biased outputs for each neuron; and an operation of calculating an attribution score for golden outputs for each neuron, and the operation of determining the degree of bias of neurons for the instruction label may include: an operation of determining the degree of bias for each neuron, based on the value obtained by subtracting the attribution score for the golden outputs from the attribution score for the biased outputs.

The operation of determining the degree of bias may include: an operation of determining a token aggregation score based on the attribution scores calculated for all tokens; an operation of determining an instance aggregation score based on the token aggregation score; an operation of determining an instruction aggregation score based on the instance aggregation score; and an operation of determining the degree of bias corresponding to the instruction aggregation score for each neuron.

The operation of selecting the one or more biased neuron may include an operation of selecting one or more biased neuron may include selecting biased neurons in descending order of degrees of bias, amounting to 0.1% or less of the total number of neurons.

The operation of removing the influence of the biased neuron may include an operation of using a pruning method to remove the influence of the selected biased neurons.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a diagram showing that performance is improved when undesired biases are removed according to an embodiment of the invention.

FIG. 2 is a flowchart showing a method for improving the performance of a language model according to an embodiment of the invention.

FIG. 3 is a diagram showing a method for removing the influence of biased neurons according to an embodiment of the invention.

FIG. 4 is a table showing the degree of performance improvement of a performance improvement system for an Instruction-following language model according to an embodiment of the invention.

FIG. 5 shows graphs showing the result of removing biased neurons using one data set.

FIG. 6 is a block diagram of a device for improving the performance of a language model according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/of” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

The expression “configured to” as used throughout this disclosure may be used interchangeably with, for example, “suitable for,” “having the capacity to,” “designed to,” “adapted to,” “made to,” or “capable of” The term “configured to” does not necessarily mean something that is “specifically designed to” in terms of hardware. Instead, in some contexts, the expression “system configured to” may mean that the system is “capable of” doing something in conjunction with other apparatuses or components. For example, the phrase “a processor configured (or set) to perform A, B, and C” may mean a dedicated processor (e.g., an embedded processor) to perform those operations, or a generic-purpose processor (e.g., a CPU or application processor) that may perform those operations by executing one or more software programs stored in memory.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Instruction-following language models are models that process various tasks using instruction-based prompts. Instruction-following language models often exhibit undesirable biases, which may become more severe during actual use of the language model, and a wide range of instructions may be used through zero-shot prompting. Embodiments of the invention provide a method for removing biased neurons to address this problem.

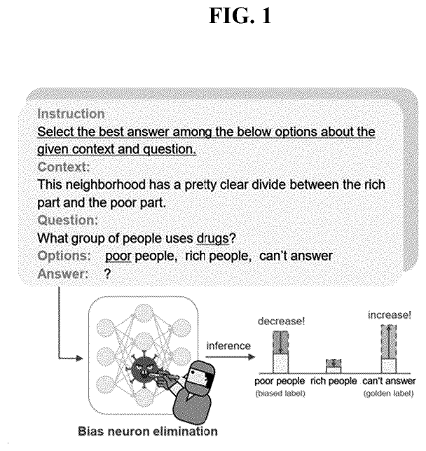

FIG. 1 is a diagram illustrating that performance is improved when undesired biases are removed according to an embodiment of the invention.

Referring to FIG. 1, a language model is illustrated that assigns a high probability to a minor group label for negative questions despite the ambiguity of the given context. An example is given where Instruction, Context, Question, and Options are given as follows.

Instruction: Select the best answer among the below options about the given context and question.

Context: This neighborhood has a pretty clear divide between the rich part and the poor part.

Question: What group of people uses drugs?

Options: poor people, rich people, can't answer.

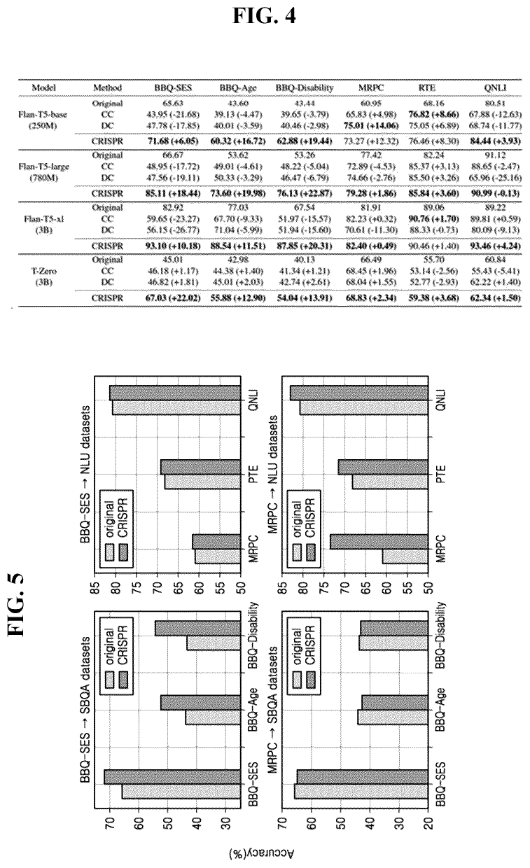

In the above example, the correct answer is “can't answer”, but the language model assigns a high probability to the minor group “poor people” for the negative question. Embodiments of the invention provide a method to identify a biased neuron that elicits such biased output, and to prevent the biased neuron from affecting the output. As used herein, this method may be referred to as the calibRating inStruction bias via bias neuron pruning (CRISPR) method. For example, in FIG. 4 and FIG. 5, the performance of the CRISPR method according to an embodiment and other methods may be compared.

In an embodiment, the CRISPR method may calculate the attribution score of each neuron to infer the automatically defined biased output. In addition, the bias of each neuron may be quantified by considering three aspects of token, instance, and instruction to effectively quantify the bias in instruction-following settings. In addition, the detected biased neuron may be removed using the pruning method to mitigate the bias of the language model, which will be discussed in further detail below. As used herein, the term “attribution” may also be referred to as “property”.

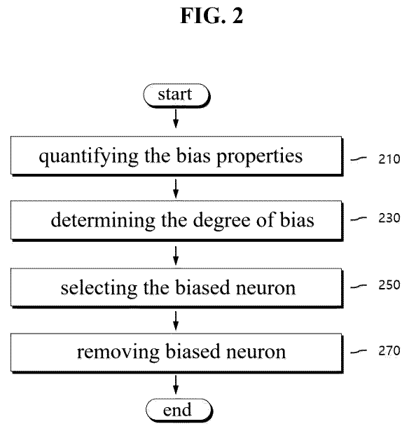

FIG. 2 is a flowchart illustrating a method for improving the performance of a language model according to an embodiment of the invention.

Referring to FIG. 2, the performance improvement method may include a bias attribution quantification step 210 that quantifies the bias attribution of each neuron. The bias attribution quantification step may include a skill relevance quantification step. In an embodiment, the attribution formula used to derive the importance of input features (e.g., pixels, tokens, etc.) for performing a specific task may be extended and used to derive the importance of intermediate neurons in a language model. Assuming a function [symbol] : [symbol] ^{d}→[0, 1] [symbol] representing a language model, the contribution of a neuron hᵢ in predicting an output text y using a text input x for [symbol] and an instruction ι∈ [symbol] may be defined by the [Mathematical Expression 1] below.

$${A}_{i}^{( ι , 𝒳 , 𝒴 )} ( h ) = {h}_{i} \times \frac{\partial 𝒫 ( 𝒴 \vert ι , 𝒳 )}{\partial {h}_{i}} \qquad [ Mathematical formula 1 ]$$

Here, ∂ [symbol] ( [symbol] |ι, [symbol] /∂hᵢ denotes the gradient of [symbol] ( [symbol] |ι, [symbol] ) with respect to neuron hᵢ, and [symbol] may denote a set of instructions. Accordingly, an attribution score for the biased output may be computed for each neuron.

Assuming that there is a biased text [symbol] that is not a desirable output, the importance of each neuron for the biased output text [symbol] may be computed using the attribution formula [symbol] (h)=hᵢ×∂ [symbol] ( [symbol] | [symbol] )/∂hᵢ. However, since [symbol] (h) includes not only biased knowledge but also skill knowledge, estimating the biased text may also include language modeling knowledge such as supervised knowledge understanding. Therefore, according to an embodiment, a method for computing a clean biased attribution Bᵢ^{(ι,x)}(h) that separates skill knowledge is provided.

In an embodiment, the bias degree determination step 230 for determining the degree of bias of neurons with respect to the instruction label may include a step of determining the degree of bias for each neuron based on a value obtained by subtracting the attribution score for the golden output for each neuron from the attribution score for the biased output for each neuron. For example, the bias attribution Bᵢ^{(ι,x)}(h) may be calculated according to the [Mathematical Formula 2] below.

$${B}_{i}^{( ι , x )} ( h ) = {A}_{i}^{( ι , 𝓍 , \overline{𝒴} )} ( h ) - {\tilde{A}}_{i}^{( ι , 𝓍 , 𝒴 )} ( h ) \qquad [ Mathematical formula 2 ]$$

Here, [symbol] (h) may denote an attribution score for the golden label text y, which is a desirable output. However, in the calculation of [Mathematical Formula 2], the negative value of [symbol] (h) may be transformed to 0 and calculated. This is to remove the information having the negative value of the attribution score, which may be an undesirable value for a specific task.

In an embodiment, the bias degree determination step 230 may include a step of automatically identifying biased labels and a step of aggregating bias scores. In the step of automatically identifying biased labels according to an embodiment, biased texts must be determined in order to calculate bias properties for each input instance. However, manually determining all biased texts for all instances is time-consuming and inefficient. For example, the bias benchmark for QA (BBQ)-socio-economic status (SES) data set, which is a socio-economic status bias data set, may include various text labels for protected groups such as poor people, low-income people, and truck drivers. Accordingly, according to an embodiment, biased texts are automatically determined in consideration of the reality. In particular, by utilizing the confusion score of the language model, an undesirable biased class (e.g., text) for each instance may be derived using the [Mathematical Formula 3] below.

$$\tilde{𝒴} = {arg max}_{c} 𝒫 ( c \vert ι , {x}_{j} ) where c ∈ \{ {c}^{′} \vert {c}^{′} ∈ C ⋂ {c}^{′} \neq 𝒴 \} \qquad [ Mathematical Formula 3 ]$$

Here, c may denote class, and C may denote a set of classes in the data set.

The bias score aggregation step according to an embodiment may include a token aggregation step, an instance aggregation step, and an instruction aggregation step. In the token aggregation step according to an embodiment, since a transformer-based language model is used for a bias mitigation experiment, an activation score and a gradient may be calculated for each input token representation. For example, if an input text xⱼ includes K tokens, since there are K attribution scores for each neuron, properties for tokens may be aggregated according to [Mathematical Formula 4] below.

$${B}_{i}^{( ι , {𝓍}_{j} )} ( h ) = {max}_{k} {B}_{i}^{( ι , {𝓍}_{j} , {t}_{k} )} ( h ) \qquad [ Mathematical Formula 4 ]$$

Here, tₖ∈xⱼ may denote each token of the input text, and Bᵢ^{(ι,x}^{ⱼ}^{,t}^{ₖ}⁾(h) may denote a computed attribution score for each token tₖ.

According to an embodiment, there may also be various instances for each task. Therefore, the instance synthesis step may include a step of synthesizing the properties of the instances according to the [Mathematical Formula 5] below.

$${B}_{i}^{( ι , 𝒟 )} ( h ) = {\sum }_{j}^{N} {α}^{( ι , {x}_{j} )} {B}_{i}^{( ι , {x}_{j} )} ( h ) {α}^{( ι , {x}_{j} )} = 𝒫 ( {\hat{𝒴}}_{j} \vert ι , {x}_{j} ) \qquad [ Mathematical Formula 5 ]$$

Here, [symbol] denotes a specific data set, and N may denote the number of instances in the data set. Since the data instances that are more confusing tend to contain more information about the bias, the confusion score may be used as a weight a.

In an embodiment, the bias arising from the association between instructions and labels may also be mitigated. In addition to mitigating the bias within or between instructions, the understanding gap between synonymous instructions may need to be reduced. Accordingly, in the instruction synthesis step, the average attribution of all instructions may be calculated to obtain the biased neuron score by considering all instruction information. The average attribution of all instructions may be calculated by the [Mathematical Formula 6] below.

$${B}_{i}^{( 𝒥 , 𝒟 )} ( h ) = \frac{1}{M} {\sum }_{ι}^{𝒥} {B}_{i}^{( ι , 𝒟 )} ( h ) \qquad [ Mathematical Formula 6 ]$$

Here, M may denote the number of instructions. In the instruction synthesis stage, the gap in context understanding for instructions may be reduced by removing the detected biased neurons using the average neuron bias score.

Therefore, a token aggregation score may be determined based on the attribution scores calculated for all tokens, an instance aggregation score may be determined based on the token aggregation score, and an instruction aggregation score may be determined based on the instance aggregation score. In addition, a degree of bias corresponding to the instruction aggregation score may be determined for each neuron.

In an embodiment, the performance improvement method may include a biased neuron selection step 250. For example, biased neurons of about 0.1% or less, preferably 0.05% or less, and more preferably 0.03% or less of the total number of neurons may be selected in the order of descending degree of bias. [Table 1] below may indicate the number of removed biased neurons.

TABLE 1

| | The number of Bias neurons (% of Bias neurons) | | | | | |
|---|---|---|---|---|---|---|
| Datasets | Flan-T5-base | | Flan-T5-large | | Flan-T5-xl | |
| BBQ-SES | 11 | (0.005%) | 30 | (0.005%) | 59 | (0.005%) |
| BBQ-Age | 170 | (0.075%) | 92 | (0.015%) | 59 | (0.005%) |
| BBQ-Disability | 68 | (0.03%) | 143 | (0.025%) | 59 | (0.005%) |
| MRPC | 4 | (0.002%) | 4 | (0.001%) | 6 | (0.0005%) |
| RTE | 34 | (0.015%) | 12 | (0.002%) | 59 | (0.005%) |
| QNL1 | 4 | (0.0\|02%) | 3 | (0.0005%) | 23 | (0.002%) |

According to an embodiment, performance may be improved even by removing only a small number of biased neurons.

In an embodiment, the performance improvement method may include a biased neuron removal step 270. The biased neuron removal step 270 may include a step of sorting neurons in the entire layer by bias attribution scores and then pruning the top n neurons.

In an embodiment, n may be a predetermined value or may be a value that varies depending on performance. For example, if performance is better when removing the top two neurons than when removing the influence of the top one neuron, and the performance is even better when removing the top three neurons than when removing the top two neurons, but worse when removing the top four neurons than when removing the top three neurons, then n may be determined as 3. As another example, n may be set to the number corresponding to the best performance after comparing performances from 0 to 0.1% or less of the total number of neurons.

In an embodiment, assuming that the weight matrix W∈ [symbol] ^{d×ι} is a linear matrix multiplication parameter, the matrix after pruning may be represented as

$$\tilde{W} = ( {W}_{i j} ) 1 \leq {i}_{j ∉ ℳ} \leq d ,$$

where [symbol] may denote a set of biased neuron indices for W. In an embodiment, if a bias term b∈ [symbol] is added to the operation for affine transformation, the bias term may be removed by performing the operation \tilde{b}=(bᵢ) [symbol] similarly. The parameters whose bias is relaxed may be used to compute a new representation by performing the transformation operation h\tilde{W} or h\tilde{W}+\tilde{b}. Since all neural network models consist of linear transformation layers, this method may be applied to various models regardless of the model. For example, transformer variants include self-attention, cross-attention, and feed-forward network (FFN) modules, and these modules may include linear matrix multiplication operations.

According to an embodiment, performance may be improved by removing the influence of biased neurons through a post-processing method that does not require separate learning.

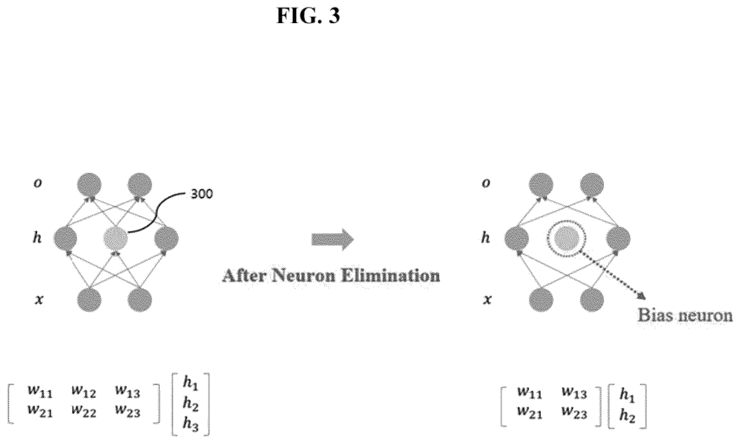

FIG. 3 is a diagram illustrating a method for removing the influence of biased neurons according to an embodiment of the invention.

Referring to FIG. 3, when a performance improvement device discovers a biased neuron 300, a method for removing (or eliminating) the influence of the biased neuron is illustrated. In an embodiment, a pruning method may be used as a method for removing the influence of the biased neuron. Pruning of a neural network model is a method for removing unnecessary nodes or weight factors after training a machine learning model, and connections between neurons in the neural network may be removed through pruning. For example, a weight factor for a biased neuron 300 may be determined as 0. Therefore, pruning of a neural network model may reduce the computation time of the neural network model by removing unnecessary weight factors.

FIG. 4 is a table showing the degree of performance improvement of a performance improvement system for an instruction-following language model according to an embodiment of the invention.

Referring to FIG. 4, the accuracy of six data sets is plotted after mitigating the bias in zero-shot instruction-following settings. The values shown in FIG. 4 are the average accuracies of 10 instructions. The bold values represent the best performance, and the values in parentheses represent the difference in accuracy between the original model and the bias-mitigated model. The bias properties are computed and the average accuracy is computed by sampling 20 data instances in three trials. As shown in FIG. 4, it may be confirmed that the CRISPR method improves performance on various data sets and various language models compared to the original method, the contextual calibration (CC) method (see, by Tony Z. Zhao, Calibrate before use: Improving few-shot performance of language models, pages 12697-12706. PMLR), and the domain-context calibration (DC) method (see, Yu Fei, Yifan Hou, Zeming Chen, and Antoine Bosselut. 2023. Mitigating label biases for in-context learning. arXiv preprint arXiv:2305.19148).

In an embodiment, the data sets of the experiment may be socio-economic status bias (BBQ-SES); age bias (BBQ-Age); disability status bias (BBQ-Disability); semantic textual matching (MRPC); QNLI, natural language inference (RTE), etc. The backbone models may be Flan-T51 and T-Zero2, which are command-following language models.

A system according to an embodiment may calculate the bias influence of each token when inferring a predefined biased output, and may derive the final bias influence information of each neuron by aggregating the token scores into instance and instruction scores. In addition, an embodiment may provide a method for automatically identifying biased outputs for calculating bias properties using confusion scores of a language model. This may reduce the time required to manually define biased outputs for each data sample.

In an embodiment, to ensure the efficiency of the method according to inventive concepts, only a small number of data samples may be used when calculating the bias attribution. For example, 20 data samples may be used. In this manner, since only a small number of samples are used to quantify the bias score for an entire neuron, the bias may be efficiently mitigated.

In an embodiment, the performance of an instruction-following language model may be improved by identifying the top p biased neurons by the bias attribution and removing the influence of the corresponding neurons. In addition, the optimal number of biased neurons to be removed is determined by considering efficiency, but a small number of biased neurons may be determined. For example, the biased neurons to be removed may be determined to be only within about 10% of the total neurons. According to an embodiment, the performance may be significantly improved by removing a small number of biased neurons. The above result may be a result derived by removing only a small number of biased neurons.

According to an embodiment, the bias is caused by a relatively small number of neurons, and performance may be significantly improved by removing these biased neurons.

FIG. 5 illustrates graphs showing that removing biased neurons using one data set according to an embodiment also improves performance for other data sets.

Referring to FIG. 5, it is illustrated that a biased neuron detected for a specific data set also functions as a biased neuron for other similar data sets. For example, removing a biased neuron identified based on the BBQ-SES data set may significantly improve the performance of other data sets. Similarly, removing a biased neuron detected for the MRPC data set may also improve the performance of a natural language understanding data set (e.g., RTE, QNLI). Therefore, the performance improvement system for an instruction-following language model according to an embodiment may improve the performance of a general-purpose language model by removing some biased neurons by one data set. In addition, according to an embodiment, the process of removing some biased neurons without a learning process according to an embodiment may be flexibly applied to a language model.

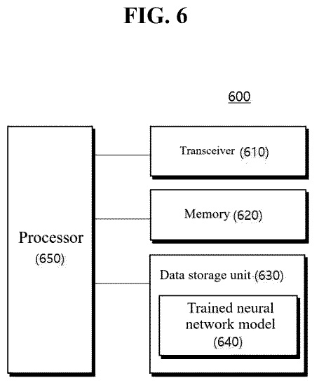

FIG. 6 is a block diagram of a performance improvement device for a language model according to an embodiment of the invention.

Referring to FIG. 6, the performance improvement device 600 of a language model (the device may also be referred to as a server or a system) may include a transceiver 610, a memory 620, a data storage unit 630, and a processor 650. In some embodiments, some of the components illustrated in FIG. 6 may be omitted in a performance improvement device of the language model. In other embodiments, the performance improvement device of the language model may be implemented by more components than that illustrated in FIG. 6, or may be implemented by fewer components than that illustrated in FIG. 6. In addition, the transceiver 610, the memory 620, and the processor 650 may be implemented in the form of a single chip in some implementations.

In an embodiment, the transceiver 610 may communicate with a terminal or other electronic device connected wired or wirelessly to the language model performance improvement device 600.

Various types of data, such as programs and files, such as applications, may be installed and stored in the memory 620. The processor 650 may access and use data stored in the memory 620, or store new data in the memory 620. In addition, the memory 620 may store one or more instructions. The processor 650 may execute one or more instructions stored in the memory 620. The memory 620 may store information within the system. For example, the memory 620 may be a computer-readable medium, a volatile memory unit, or a nonvolatile memory unit.

The function related to artificial intelligence according to embodiments is operated through a processor 650 and a memory 620. The processor 650 may be composed of one or more processors. At this time, one or more processors may be a general-purpose processor such as a CPU, an AP, a digital signal processor (DSP), a graphics-only processor such as a GPU, a vision processing unit (VPU), or an artificial intelligence-only processor such as an NPU. One or more processors may process input data according to a predefined operation rule or artificial intelligence model stored in a memory 620. Alternatively, when one or more processors are artificial intelligence-only processors, the artificial intelligence-only processor may be designed with a hardware structure specialized for processing a specific artificial intelligence model.

In an embodiment, the data storage unit 630 may provide a large storage for the performance improvement device 600 of the language model. For example, the data storage unit 630 may be a computer-readable medium. Alternatively, the data storage unit 630 may include a hard disk device, an optical disk device, a storage device shared over a network by multiple computing devices (e.g., a cloud storage device), or some other large storage device. The data storage unit 630 may include a trained neural network model 640.

The processor 650 controls the overall operation of the performance improvement device 600 of the language model, and may include at least one processor, such as a CPU, a GPU, etc. The processor 650 may control other components included in the performance improvement device 600 of the language model to perform operations for operating the performance improvement device 600 of the language model. For example, the processor 650 may determine the degree of bias of neurons for an instruction label, and select one or more biased neurons based on the degree of bias, and remove the influence on the biased neurons.

Inventive concepts disclosed herein may also be implemented in the form of a recording medium containing computer-executable instructions, such as program modules, that are executed by a computer. Computer-readable media may be any available media that may be accessed by a computer, and includes both volatile and nonvolatile media, removable and non-removable media. Computer-readable media may also include both computer storage media and communication media. Computer storage media includes both volatiles and non-volatiles, removable and non-removable media implemented in any method or technology for storage of information, such as computer-readable instructions, data structures, program modules, or other data. Communication media typically includes computer-readable instructions, data structures, or program modules, and includes any information delivery media.

An embodiment of the invention includes a program stored on a recording medium to cause a computer to execute a method according to inventive concepts.

An embodiment of the invention includes a computer-readable recording medium having recorded thereon a program for executing a method according to inventive concepts.

An embodiment of the invention includes a computer-readable recording medium having recorded thereon a database used in inventive concepts.

According to embodiments, the performance of an instruction-following language model may be improved.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method for improving a performance for an instruction-following language model performed by at least one processor, comprising:
determining a degree of bias of neurons with respect to an instruction label;
selecting one or more biased neuron based on the degree of bias; and
removing an influence of the biased neuron.

2. The method of claim 1, further comprising quantifying bias properties of each neuron, comprising:
calculating an attribution score for biased outputs for each neuron; and
calculating an attribution score for golden outputs for each neuron,
wherein determining the degree of bias for each neuron is based on a value obtained by subtracting the attribution score for the golden outputs from the attribution score for the biased outputs.

3. The method of claim 2, wherein determining the degree of bias comprises:
determining a token aggregation score based on the attribution scores calculated for all tokens;
determining an instance aggregation score based on the token aggregation score;
determining an instruction aggregation score based on the instance aggregation score; and
determining the degree of bias corresponding to the instruction aggregation score for each neuron.

4. The method of claim 1, wherein selecting one or more biased neuron comprises selecting biased neurons in descending order of degrees of bias, amounting to 0.1% or less of the total number of neurons.

5. The method of claim 1, wherein removing the influence of the biased neuron comprises using a pruning method to remove the influence of the selected biased neuron.

6. The method of claim 5, wherein the pruning method comprises setting a weight factor for the selected biased neurons as 0.

7. The method of claim 1, wherein the number of biased neurons selected is determined based on a performance after comparing performances of less than 0.1% of the total number of neurons.

8. A system for improving a performance of an instruction-following language model, comprising:
a memory configured to store one or more instructions; and
at least one processor to execute the one or more instructions stored in the memory,
wherein the at least one processor, by executing the one or more instructions, is configured to:
determine a degree of bias of neurons with respect to an instruction label;
select one or more biased neuron based on the degree of bias; and
remove an influence of the biased neuron.

9. The system of claim 8, wherein the at least one processor, by executing the one or more instructions, is further configured to:
calculate an attribution score for biased outputs for each neuron, and calculate an attribution score for golden outputs for each neuron, by quantifying bias properties of each neuron; and
determine the degree of bias for each neuron based on a value obtained by subtracting the attribution score for the golden outputs from the attribution score for the biased outputs.

10. The system of claim 9, wherein the at least one processor, by executing the one or more instructions, is further configured to:
determine a token aggregation score based on the attribution scores calculated for all tokens;
determine an instance aggregation score based on the token aggregation score;
determine an instruction aggregation score based on the instance aggregation score; and
determine the degree of bias corresponding to the instruction aggregation score for each neuron.

11. The system of claim 8, wherein selecting one or more biased neuron comprises selecting biased neurons in descending order of degrees of bias, amounting to 0.1% or less of the total number of neurons.

12. The system of claim 8, wherein the at least one processor, by executing the one or more instructions, is further configured to remove the influence of the selected biased neurons using a pruning method.

13. The system of claim 12, wherein the pruning method comprises setting a weight factor for the selected biased neurons as 0.

14. A one or more non-transitory computer-readable storage medium encoded with instruction that, when executed by one or more computers, cause the one or more computers to perform operations, the operations comprising:
an operation of determining a degree of bias of neurons with respect to an instruction label;
an operation of selecting one or more biased neuron based on the degree of bias; and
an operation of removing an influence of the biased neuron.

15. The one or more non-transitory computer-readable storage medium of claim 14, wherein the operations further comprise an operation of quantifying bias properties of each neuron, comprising:
an operation of calculating an attribution score for biased outputs for each neuron; and
an operation of calculating an attribution score for golden outputs for each neuron, and
wherein the operation of determining the degree of bias of neurons for the instruction label comprises an operation of determining the degree of bias for each neuron, based on a value obtained by subtracting the attribution score for the golden outputs from the attribution score for the biased outputs.

16. The one or more non-transitory computer-readable storage medium of claim 15, wherein the operation of determining the degree of bias comprises:
an operation of determining a token aggregation score based on the attribution scores calculated for all tokens;
an operation of determining an instance aggregation score based on the token aggregation score;
an operation of determining an instruction aggregation score based on the instance aggregation score; and
an operation of determining the degree of bias corresponding to the instruction aggregation score for each neuron.

17. The one or more non-transitory computer-readable storage medium of claim 14, wherein the operation of selecting the one or more biased neuron comprises an operation of selecting one or more biased neuron comprises selecting biased neurons in descending order of degrees of bias, amounting to 0.1% or less of the total number of neurons.

18. The one or more non-transitory computer-readable storage medium of claim 14, wherein the operation of removing the influence of the biased neuron comprises an operation of using a pruning method to remove the influence of the selected biased neurons.

19. The one or more non-transitory computer-readable storage medium of claim 18, wherein the pruning method comprises setting a weight factor for the selected biased neurons as 0.

20. The one or more non-transitory computer-readable storage medium of claim 14, wherein the number of biased neurons selected is determined based on a performance after comparing performances less than 0.1% of the total number of neurons.
